(19) United States
(12) Patent Application Publication
(10) Pub. No.: US 2026/0238750 A1
(43) Pub. Date: Aug. 13, 2026

(54) PROJECTION CONTROL DEVICE CONVERTING IMAGE DATA FOR PROJECTION BY PROJECTOR HAVING FISHEYE LENS

(71) Applicant: Brother Kogyo Kabushiki Kaisha, Nagoya (JP)

(72) Inventor: Kentaro Ushiyama, Nagoya (JP)

(21) Appl. No.: 19/631,711

(22) Filed: Mar. 27, 2026

Related U.S. Application Data
(63) Continuation of application No. PCT/JP2024/033048, filed on Sep. 17, 2024.

(30) Foreign Application Priority Data
Sep. 29, 2023 (JP) 2023-170426

(51) Int. Cl. H04N 13/275; H04N 13/139; H04N 13/307; H04N 13/327

(52) U.S. Cl. CPC H04N 13/275; H04N 13/139; H04N 13/307; H04N 13/327

(57) ABSTRACT

A controller of a projection control device selects a target virtual projector based on an imaging condition of first image data. The controller captures, in a virtual space, second image data representing a model projection surface using a virtual fisheye lens at a virtual lens position. The model projection surface corresponds to a projection surface in a physical space. The controller identifies sets of two-dimensional pixel coordinates in the second image data. Each sets corresponds to a portion of the model projection surface. The controller virtually projects an image based on the first image data onto the model projection surface using the target virtual projector, and generates third image data based on the sets of two-dimensional pixel coordinates and the virtually projected image. The controller projects an image based on the third image data onto the projection surface using a projector including a fisheye lens.

### REFERENCE TO RELATED APPLICATIONS

This is a by-pass continuation application of International Application No. PCT/JP2024/033048 filed on September 17, 2024 claiming priority from Japanese Patent Application No. 2023-170426 filed on September 29, 2023. The entire contents of the International Application and the priority application are incorporated herein by reference.

### BACKGROUND ART

A known projection method assumes the appearance of a projected image obtained when projected onto a dome-shaped projection surface whose concave surface faces the observer, such that the center of the dome-shaped projection surface coincides with the center of the projected image. The image to be projected is then transformed so that the image projected by a projector installed at an arbitrary position matches the assumed projected image.

### SUMMARY

The known projection method performs a complex process of adjusting the waveforms of horizontal and vertical scanning voltages used by the projector to transform the image being projected. Moreover, since the known projection method processes image data using a single processing method, distortion is produced in the projected image if the conditions under which the inputted image data was captured differ from the assumed conditions.

In view of the foregoing, it is an object of the present disclosure to provide a projection system, a projection control device, and a projection control program for projecting, from a projector onto a 3D projection surface having a concave surface, an image having less distortion than those produced in the known method, depending on an imaging condition of image data.

In order to attain the above and other objects, the present disclosure provides a projection system. The projection system includes a projector and a projection control device. The projector includes a fisheye lens. The projection control device is configured to perform: an image obtaining process including: obtaining first image data captured under an imaging condition; a model setting process including: obtaining model parameters defining a three-dimensional model represented in a virtual space, the three-dimensional model including a model projection surface, the model projection surface corresponding to a projection surface in a physical space; a virtual projector setting process including: selecting a target virtual projector from a plurality of virtual projectors based on the imaging condition; a pixel-position identifying process including: virtually capturing, in the virtual space, second image data representing the model projection surface using a virtual fisheye lens at a virtual lens position, a positional relationship between the virtual lens position and the model projection surface corresponding to a positional relationship between an installation position and the projection surface in the physical space; and identifying one or more sets of two-dimensional pixel coordinates in the second image data, each of the one or more sets of two-dimensional pixel coordinates corresponding to a portion of the model projection surface; a generating process including: virtually projecting, in the virtual space, an image based on the first image data onto the model projection surface using the target virtual projector located at a prescribed position; and generating third image data based on the one or more sets of two-dimensional pixel coordinates and the virtually projected image; and a projecting process including: projecting an image based on the third image data onto the projection surface using the projector in a state where the projector is placed at the installation position.

According to another aspects, the disclosure provides a projection control device. The projection control device includes a controller including one or more processors. The controller is configured to perform: an image obtaining process including: obtaining first image data captured under an imaging condition; a model setting process including: obtaining model parameters defining a three-dimensional model represented in a virtual space, the three-dimensional model including a model projection surface, the model projection surface corresponding to a projection surface in a physical space; a virtual projector setting process including: selecting a target virtual projector from a plurality of virtual projectors based on the imaging condition; a pixel-position identifying process including: virtually capturing, in the virtual space, second image data representing the model projection surface using a virtual fisheye lens at a virtual lens position, a positional relationship between the virtual lens position and the model projection surface corresponding to a positional relationship between an installation position and the projection surface in the physical space; and identifying one or more sets of two-dimensional pixel coordinates in the second image data, each of the one or more sets of two-dimensional pixel coordinates corresponding to a portion of the model projection surface; a generating process including: virtually projecting, in the virtual space, an image based on the first image data onto the model projection surface using the target virtual projector located at a prescribed position; and generating third image data based on the one or more sets of two-dimensional pixel coordinates and the virtually projected image; and a projecting process including: projecting an image based on the third image data onto the projection surface using a projector including a fisheye lens in a state where the projector is placed at the installation position.

According to still another aspects, the disclosure provides a non-transitory computer readable storage medium having instructions stored thereon that, when executed, cause a controller, which includes one or more processors, to perform: an image obtaining process including: obtaining first image data captured under an imaging condition; a model setting process including: obtaining model parameters defining a three-dimensional model represented in a virtual space, the three-dimensional model including a model projection surface, the model projection surface corresponding to a projection surface in a physical space; a virtual projector setting process including: selecting a target virtual projector from a plurality of virtual projectors based on the imaging condition; a pixel-position identifying process including: virtually capturing, in the virtual space, second image data representing the model projection surface using a virtual fisheye lens at a virtual lens position, a positional relationship between the virtual lens position and the model projection surface corresponding to a positional relationship between an installation position and the projection surface in the physical space; and identifying one or more sets of two-dimensional pixel coordinates in the second image data, each of the one or more sets of two-dimensional pixel coordinates corresponding to a portion of the model projection surface; a generating process including: virtually projecting, in the virtual space, an image based on the first image data onto the model projection surface using the target virtual projector located at a prescribed position; and generating third image data based on the one or more sets of two-dimensional pixel coordinates and the virtually projected image; and a projecting process including: projecting an image based on the third image data onto the projection surface using a projector including a fisheye lens in a state where the projector is placed at the installation position.

Normally, when an image is projected by a projector with a fisheye lens, distortion specific to that fisheye lens is produced in the projected image. Similarly, when an image is captured by a camera with a fisheye lens, distortion specific to that fisheye lens is produced in the captured image. Since image capture and image projection are inverse conversions, distortion produced during image capture is offset by image projection when the image data captured with a fisheye lens is projected with a fisheye lens having the same characteristics as the fisheye lens used for image capture. As a result, a projected image with reduced distortion can be obtained without performing any correction specific to the fisheye lens.

In the above structures, the converted image data is obtained by virtually projecting an image projected by the virtual projector in the virtual environment and capturing the virtually projected image the virtual fisheye lens at the position corresponding to the installation position of the projector based on an image.

In the above structures, an ideal projection environment is simulated using the virtual projector selected based on the imaging condition, and the third image data is generated based on the projecting results obtained in the ideal projection environment. The third image data indicates an image obtained by capturing the projecting results using the virtual fisheye lens at the virtual lens position. Accordingly, the projection results in the ideal projection environment can be reproduced through projection from a realistic projection environment through a relatively simple process, and thus the image with less distortion can be projected. Further, regardless of whether the projection surface has a three-dimensional structure or a flat shape, the image with less distortion can be projected onto the projection surface based on image data captured in any imaging condition, causing less discomfort to the viewer.

### BRIEF DESCRIPTION OF DRAWINGS

FIGS. 1A and 1B are illustrations of a projection system including a projector is suspended from a ceiling of a room.

FIG. 2 is a flowchart illustrating a projection control process executed by a projection control device.

FIGS. 3A and 3B are perspective views illustrating 3D models.

FIGS. 3C and 3D are illustrations of a virtual projector at a prescribed position and a virtual camera at an installation position.

FIG. 4A is an illustration of a 3D projection surface.

FIG. 4B is an illustration of a reference image projected onto the 3D projection surface.

FIG. 4C is an illustration of a reference image projected onto a modified 3D projection surface.

FIG. 5 is a flowchart of a conversion process.

FIG. 6A is an illustration of image data captured using a standard lens.

FIG. 6B is an illustration of projection results of 2D image data onto the 3D projection surface according to Example 1.

FIG. 6C is an illustration of projection results of 2D image data onto the 3D projection surface according to a comparative example.

FIG. 7A is an illustration of image data captured using a fisheye lens.

FIG. 7B is an illustration of projection results of 2D image data onto the 3D projection surface according to Example 2.

FIG. 7C is an illustration of projection results of 2D image data onto the 3D projection surface according to Example 3.

FIG. 8A is an illustration of image data captured using a 360-degree camera.

FIG. 8B is an illustration of projection results of 2D image data onto the 3D projection surface according to Example 4.

FIG. 9A is an illustration of projection results when a projection position is modified.

FIG. 9B is an illustration of projection results before the projection position is modified and before a projection magnification is modified.

FIG. 9C is an illustration of projection results when the projection magnification is modified.

### DESCRIPTION

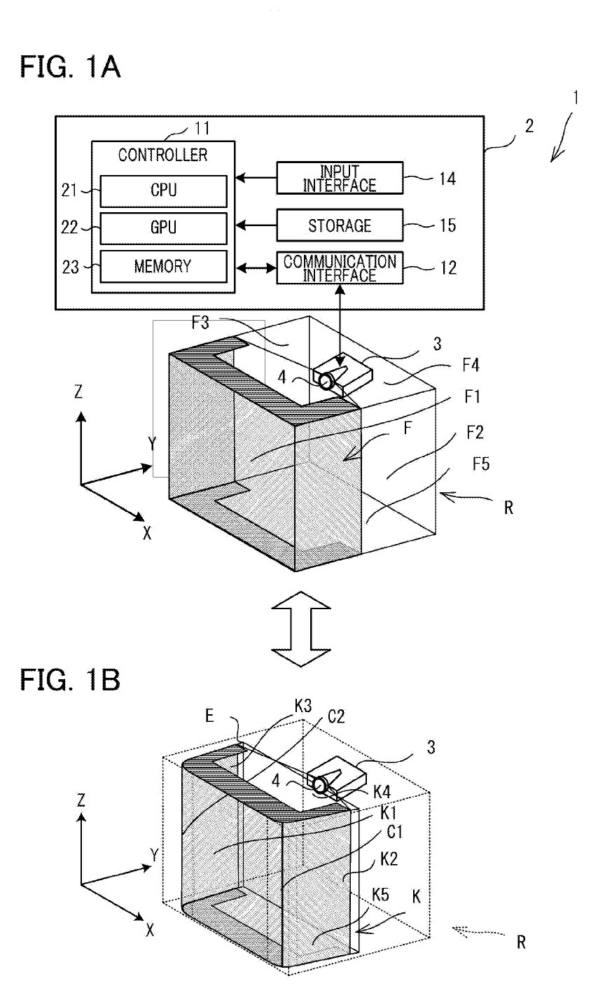

Below, an embodiment of the present disclosure will be described while referring to the accompanying drawings. The following description will use the X, Y, and Z directions shown in FIG. 1A. The Z direction is the vertical direction, while the X and Y directions are horizontal directions that are perpendicular to the Z direction. The X, Y, and Z directions are perpendicular to each other.

FIG. 1A shows a projection system 1. The projection system 1 has a projector 3 with a fisheye lens 4, and a projection control device 2 that controls the images to be projected by the projector 3. The projector 3 and the projection control device 2 are connected to each other via a wired or wireless connection. The projection system 1 is used in a room R of an amusement facility, such as a karaoke establishment. The projector 3 is suspended from the ceiling of the room R, for example. In the embodiment, the term “fisheye lens” may indicate a lens configured to form an image according to a non-rectilinear projection model, such as an equidistant projection model. Further, the term “standard lens” described below may indicate a non-fisheye lens and may indicate a lens configured to form an image according to a rectilinear projection model (perspective projection model, or a central projection model).

The projector 3 projects image data onto a 3D projection surface, which is concave, in accordance with image signals outputted from the projection control device 2. The 3D projection surface may have any shape that is concave. The present embodiment employs a 3D projection surface F shown in FIG. 1A or a 3D projection surface K shown in FIG. 1B.

As shown in FIG. 1A, the 3D projection surface F having five surfaces (flat surfaces) from among the six inner surfaces of the cubic room R, including a first surface F1 facing the fisheye lens 4 of the projector 3, and four surfaces F2 through F5 that are continuous with the first surface F1. The first surface F1 extends vertically. The second surface F2 and third surface F3 are each orthogonal to the first surface F1 and extend vertically. The fourth surface F4 and fifth surface F5 are each orthogonal to the first surface F1 and extend horizontally.

As shown in FIG. 1B, the 3D projection surface K is formed on the concave surface of a screen E that can be installed in the cubic room R. The 3D projection surface K has five surfaces, including a first surface K1 that faces the fisheye lens 4 of the projector 3, and four surfaces K2 through K5 that are continuous with the first surface K1. The first surface K1 extends vertically. The second surface K2 and third surface K3 each intersect the first surface K1 and extend vertically. The fourth surface K4 and fifth surface K5 are each orthogonal to the first surface K1 and extend horizontally. The first through fifth surfaces K1-K5 are flat surfaces.

The first surface K1 and second surface K2 are connected by a first curved surface C1, and the first surface K1 and third surface K3 are connected by a second curved surface C2. The distance between the second surface K2 and the third surface K3 increases toward the side away from the first surface K1 to reduce discomfort for viewers observing the projected results from positions farther away from the screen E. The screen E is arranged so that its surface on the opposite side of the first surface K1 faces and is adjacent to the first surface F1 of the room R. In this embodiment, the first surface F1 is a wall surface of the room R, but the first surface F1 may be either the ceiling or floor surface of the room R. In FIG. 1B, the first curved surface C1 is illustrated as a straight line connecting the first surface K1 and the second surface K2. However, the first curved surface C1 is actually a curved-band region extending between the first surface K1 and the second surface K1 that includes that straight line, and the first curved surface C1 has a curved line in a cross-sectional view taken along a horizontal plane. This holds true for the second curved surface C2.

The projection control device 2 converts image data into 2D image data for projection (hereinafter, simply referred to as “2D image data”) and controls projection from the projector 3 based on the 2D image data. The projection control device 2 may be installed at any position in the room R or in a separate location from the room R. The projection control device 2 includes a communication interface 12, a storage 15, an input interface 14, and a controller 11. The communication interface 12, storage 15, and input interface 14 are connected to the controller 11.

The storage 15 includes a hard disk drive, for example. The storage 15 stores an operating system (OS), and various programs. The programs include a projection control program that instructs a central processing unit (CPU) 21 of the controller 11 to execute a projection control process. The storage 15 stores image data to be projected, internal and external parameters of the projector 3, internal and external parameters of a virtual projector PR, internal and external parameters of a virtual camera CA, various parameters for executing the projection control process. The image data includes imaging conditions. In the present embodiment, each imaging condition includes information on the lens used for imaging, characteristics of the lens used for imaging, and the type of camera. As used herein, the terms “virtual” and “virtually” generally refer to processing performed by one or more processors through computational operations, such as numerical calculation, simulation, or computer-generated rendering, within a computer-defined space, rather than physical operations in a real-world environment.

The input interface 14 receives operation instructions from the user of the projection system 1 and outputs signals to the controller 11 based on the operation instructions. For example, the input interface 14 is a game controller with a joystick and a directional pad (or a cross button, an X button).

The controller 11 includes the CPU 21, a graphics processing unit (GPU) 22, a memory 23. The GPU 22 is a processor separate from the CPU 21 that performs image processing based on instructions from the CPU 21. The memory 23 includes ROM, and RAM, for example.

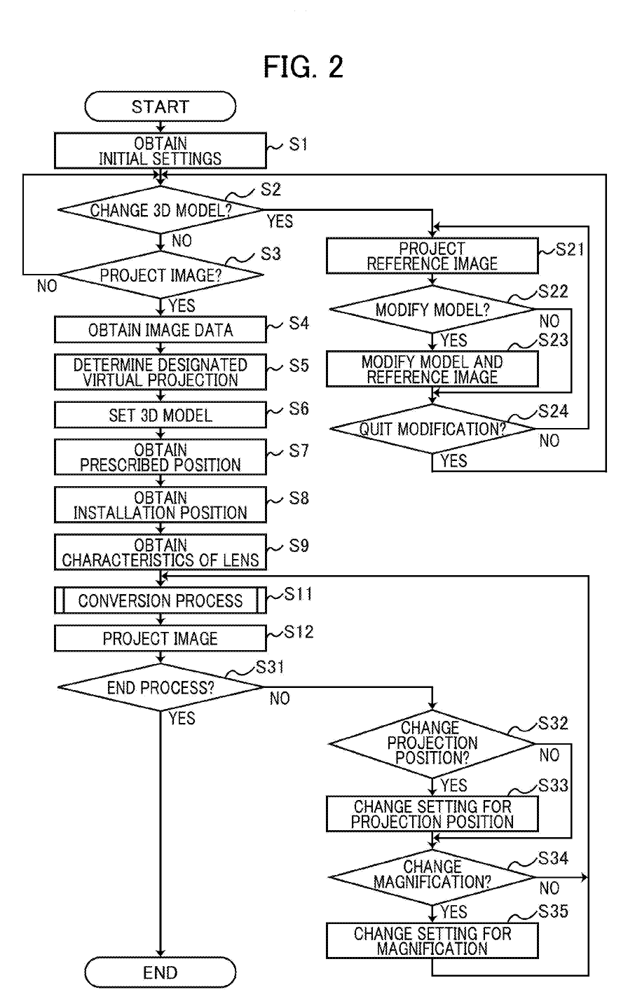

Next, specific Examples 1 through 4 of the projection control process executed by the projection control device 2 will be described with reference to FIGS. 2 through 9C. In the projection control process, the projection control device 2 projects image data specified by the user onto the 3D projection surface F. Each of Examples 1 through 4 use frames of video data captured when filming four people chatting on stage as the image data.

In Example 1, video data captured by a camera using a standard lens is projected onto the 3D projection surface F. In Example 2, video data captured by a camera using a fisheye lens is projected onto the 3D projection surface F. In Example 3, video data captured by a camera using a fisheye lens is projected onto the 3D projection surface K. In a plan view, a bounding outline of the 3D projection surface K has a trapezoidal shape with rounded edges. In Example 4, video data captured by an omnidirectional camera is projected onto the 3D projection surface F.

For Examples 1 through 4, the controller 11 uses a virtual projector corresponding to the imaging condition of the video data to generate 2D image data to be projected by the projector 3. Each virtual projector has a data format in which virtual parameters configured for calculating correspondences between pixels in the image data and a 3D model are included. Here, in the embodiment, the 3D model indicates a three-dimensional model representation of the physical shape and coordinates of the 3D projection surface. Hereinafter, “model projection surface” indicates the three-dimensional model representation of the physical shape and coordinates of the 3D projection surface. In other words, the model projection surface indicates a projection surface in a three-dimensional virtual space corresponding to the 3D projection surface in the physical space. In the present embodiment, three types of virtual projectors have been prepared for the projection control device 2 in advance. Shaders and parameters for use in virtual projection using each virtual projector are stored in the storage 15.

The three types of virtual projectors are a standard virtual projector, a fisheye virtual projector, and a 360-degree virtual projector. The standard virtual projector virtually projects image data onto a model projection surface using a virtual standard lens. The fisheye virtual projector virtually projects image data onto a model projection surface using a virtual fisheye lens. The term “virtual lens”, such as a virtual fisheye lens and a virtual standard lens, is a mathematical model or a software module configured to simulate the optical behavior of physical lenses to capture images within a virtual space. That is, the virtual lens is designed to optically emulate a physical fisheye lens by possessing optical characteristics equivalent to those of the physical lens. The 360-degree virtual projector virtually projects 360 degrees onto a model projection surface so that the elevation angle (which may indicate an upward or downward angle) and the azimuth angle of a projecting direction from the virtual projector match the e elevation angle and the azimuth angle defined by the image data. Although the projection results of the 360-degree virtual projector are virtually 360 degrees, in actuality the output is limited to the projection range of the projector 3 corresponding to the characteristics of the fisheye lens 4 obtained in step S9 described later.

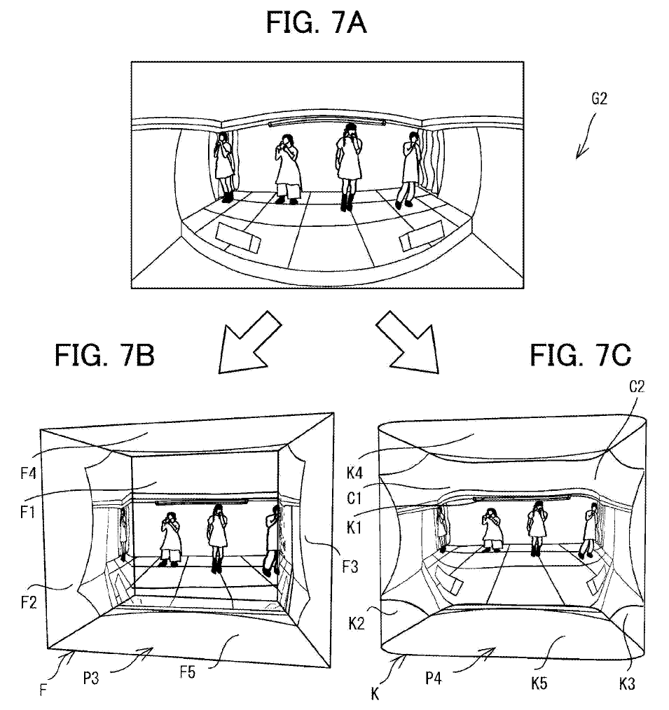

The types and numbers of virtual projectors may be adjusted as appropriate. A case of using a fisheye virtual projector in Example 1 for generating 2D image data to be projected by the projector 3 will be described below as a comparative example (see FIG. 7C).

The projection control process is started when the user inputs a start instruction. When a start instruction is detected, the controller 11 reads the projection control program stored in the storage 15 into the memory 23 to execute the projection control process. The controller 11 executes the following steps according to instructions contained in the program read into the memory 23. Various parameters for executing the projection control process are stored in the storage 15. The controller 11 stores various data obtained during the projection control process in the memory 23 as appropriate. Examples 1 through 4 are executed at different timings in the projection control process.

As shown in FIG. 2, in S1 the controller 11 obtains initial settings stored in the storage 15. The initial settings include settings for the current 3D model. The settings for the current 3D model are represented by model parameters including the size and shape of the 3D projection surface. That is, the 3D projection surface corresponds to the model projection surface included in the 3D model.

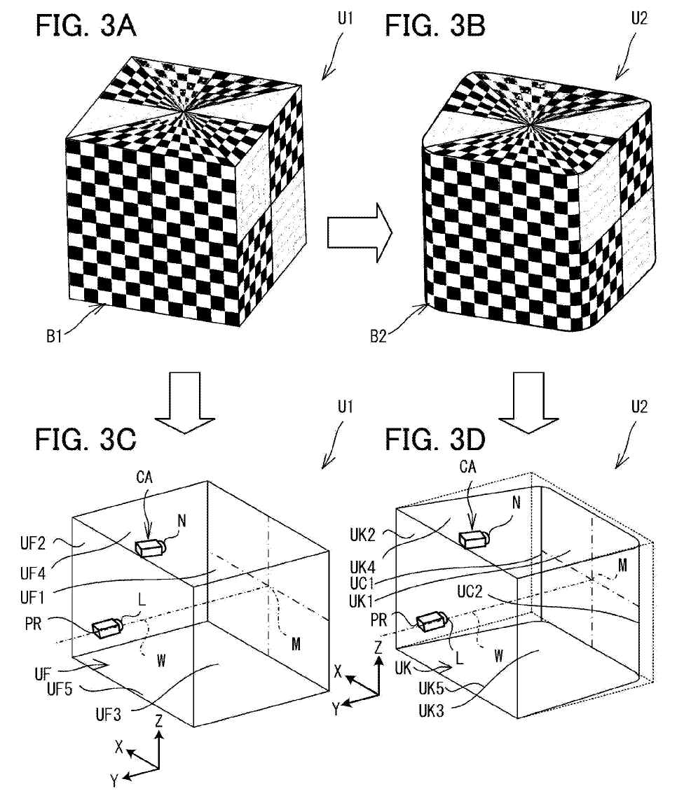

In S2 the controller 11 determines whether to change the 3D model. In this embodiment, a 3D model U1 of the cube in FIG. 3 is set as the initial value of the 3D model. The projection control device 2 in the present embodiment can modify any of the following aspects of the current 3D model: the size and shape of each surface, the curved shape of a connecting part between any two adjacent surfaces when the connecting part is a curved surface, and the trapezoidal shape of the contour of any surface when the contour has a trapezoidal shape. The controller 11 can also rotate or translate the current 3D model. Normally, the user modifies the 3D model when the position of the projector 3 relative to the 3D projection surface is changed. When the user wishes to modify settings for the current 3D model, the user inputs instructions through operations on the input interface 14 to modify the settings.

As shown in FIG. 3A, the 3D model U1 is set as the current 3D model for the 3D projection surface F in Examples 1, 2, and 4. As shown in FIG. 3B, a 3D model U2 is set as the current 3D model for the 3D projection surface K in Example 3. The settings of the 3D model U2 are modified from those of the 3D model U1 to suit the shape of the screen E.

Framework information B1 is represented by the grid pattern of the 3D model U1, and framework information B2 is represented by the grid pattern of the 3D model U2. The framework information B1 and framework information B2 are each used for mapping image data as textures when the standard virtual projector is designated in the process of S5 described later.

In this embodiment, the standard virtual projector is used by the controller 11 in a process for generating 2D image data, which is obtained by virtually projecting an image so as to conform to the shape of the model projection surface. The framework information represented by the 3D models will be described using the 3D projection surface F as an example.

The controller 11 arranges the virtually projected image based on the image data on so that the center of the data is aligned with the center of the first surface UF1 (or UK1) and sets the projection magnification factor large enough that the projected image extends beyond the first surface F1. For the projected image in areas extending from the first surface UF1 onto the second surface UF2 and third surface UF3, which are horizontally connected to the first surface UF1, the controller 11 projects the image so as to bend the portion of the projected image along connection lines of the surfaces. For the image in areas extending from the first surface UF1 onto the fourth surface UF4 and fifth surface UF5, which are perpendicularly connected to the first surface UF1, the controller 11 transforms the image so that the projected is reduced toward the center of the plane, as depicted by the grid patterns.

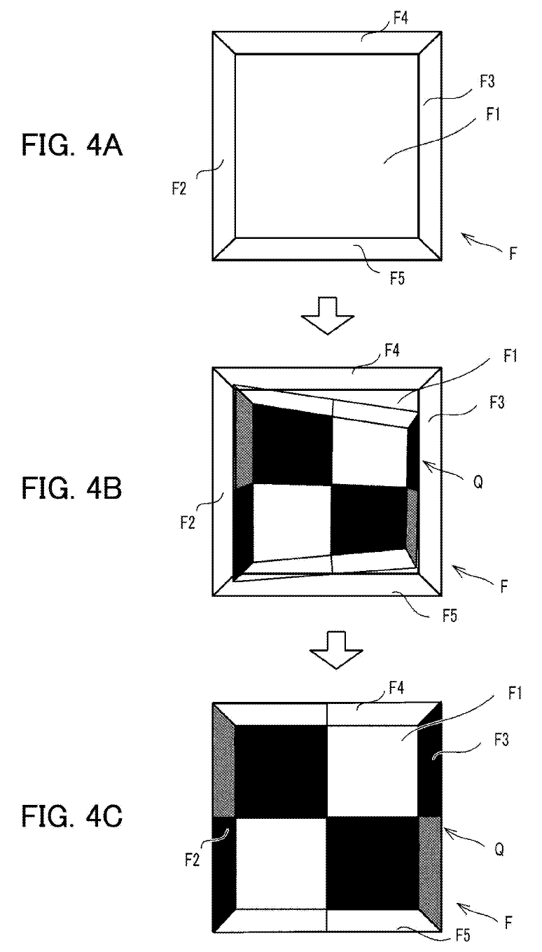

When an instruction to change settings for the unmodified 3D model U1 shown in FIG. 4A is detected (S2: YES), in S21 the controller 11 controls the projector 3 to project a reference image Q onto the 3D projection surface F via the fisheye lens 4. The reference image Q shows the configured state of the 3D model U1, as illustrated in FIG. 4B. The reference image Q may be any image showing the current configured state of the 3D model. For example, the reference image Q may be an image showing the border between each pair of adjacent surfaces or may be an image including a grid pattern representing the framework information B1 of the 3D model U1.

After the controller 11 has projected the reference image Q, in S22 the controller 11 accepts a setting modification instruction to change the configuration of the 3D model U1. The user inputs instructions by operating the input interface 14 first to select which setting to modify and then to specify the amount of change. When the controller 11 detects a setting modification instruction for the 3D model U1 (S22: YES), in S23 the controller 11 modifies the configuration of the 3D model U1 according to the instruction received in S22 and modifies the reference image Q being projected onto the 3D projection surface F. The controller 11 then projects the modified reference image Q.

Thus, the user adjusts parameters for the 3D model through operations on the input interface 14 while viewing the reference image projected on the 3D projection surface F until the reference image Q is arranged so as to conform to the 3D projection surface F, as illustrated in FIG. 4C. As shown in FIG. 4C, borders in the pattern of the reference image Q are aligned with borders between every pair of adjacent surfaces among the five surfaces constituting the 3D projection surface. Through the process in S22 and S23, the user can change the positional relationship between the room R in which the projector 3 is installed, and the projector 3; fisheye lens characteristics of the fisheye lens 4 in the projector 3, which the controller 11 will obtain in S9; the prescribed position of the virtual projector, which the controller 11 will obtain in S6; and the orientation of the designated virtual projector, which the controller 11 will designate in S5.

Following the modification in S23 or when the controller 11 does not detect a setting modification instruction for the 3D model (S22: NO), in S24 the controller 11 determines whether an instruction to quit the process to change the configuration of the 3D model is detected. When the controller 11 does not detect an instruction to quit the process for changing the configuration of the 3D model (S24: NO), the controller 11 returns to S21. Once the controller 11 detects an instruction to quit the process to change the configuration of the 3D model (S24: YES), the controller 11 returns to S2.

When the controller 11 determines in S2 that an instruction to modify a setting of the 3D model is not detected (S2: NO), in S3 the controller 11 determines whether a projection instruction for projecting the image based on the image data on the 3D projection surface is detected. When a projection instruction is not detected (S3: NO), the controller 11 returns to S2.

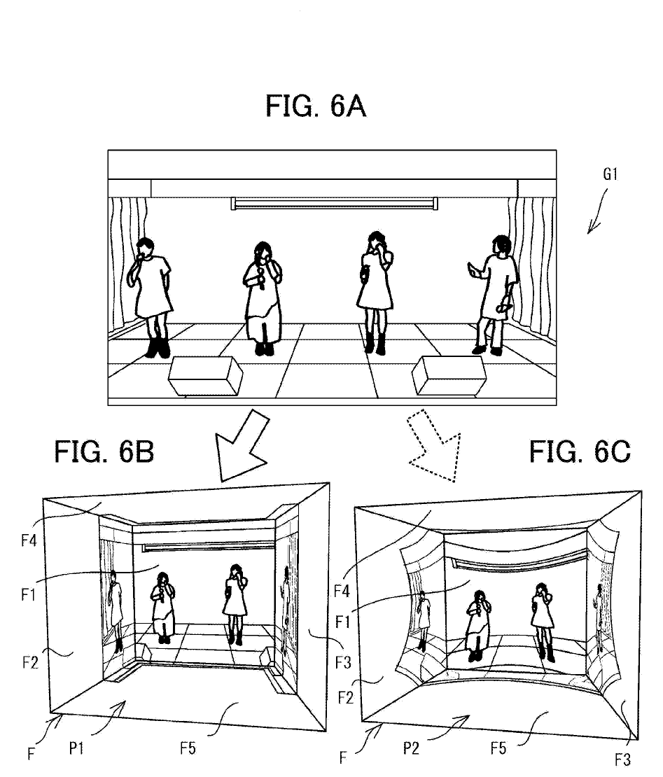

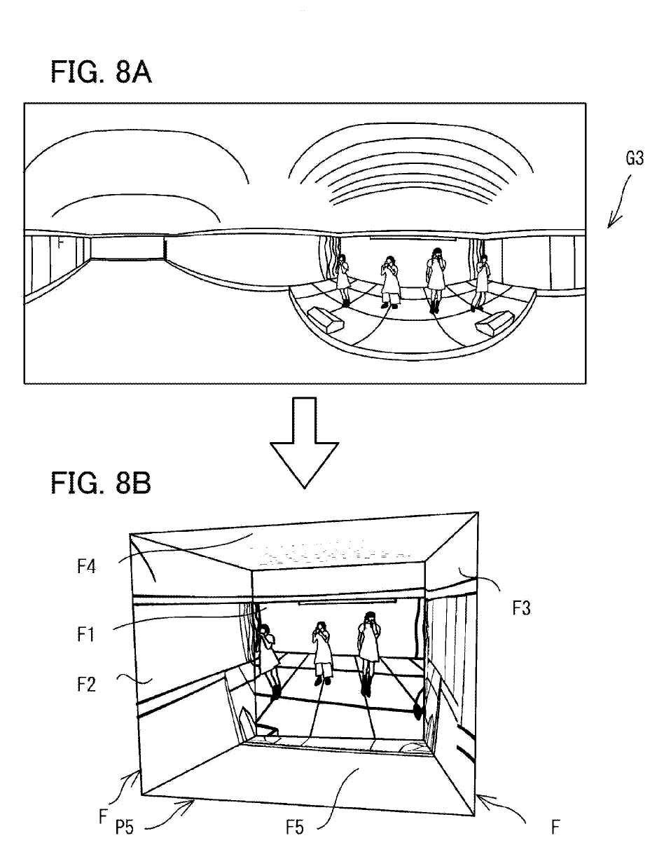

When a projection instruction is detected (S3: YES), in S4 the controller 11 obtains image data to be processed. The controller 11 may obtain this image data from another device via the communication interface 12 or may obtain the image data from the storage 15. For Example 1, the controller 11 obtains video data including image data G1 shown in FIG. 6A. For Examples 2 and 3, the controller 11 obtains video data containing image data G2 shown in FIG. 7A. For Example 4, the controller 11 obtains video data containing image data G3 shown in FIG. 8A.

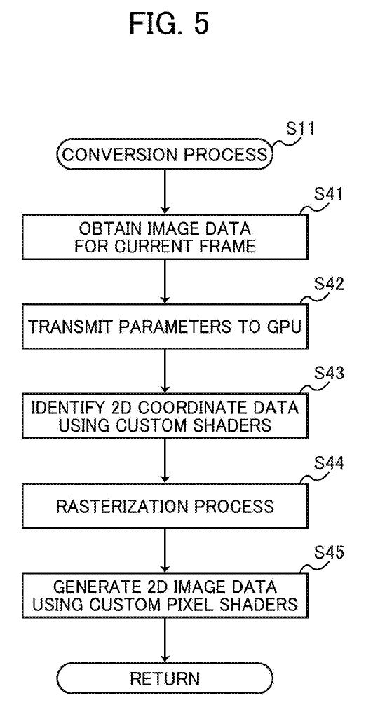

In S5 the controller 11 determines a designated virtual projector from among a plurality of preset virtual projectors based on the imaging condition for the image data. The controller 11 determines the designated virtual projector in the process of S5 based on the imaging condition included in the image data. The controller 11 designates the fisheye virtual projector when the imaging condition includes a condition indicating a fisheye lens being used for capturing the image, as in Examples 2 and 3. The controller 11 designates the standard virtual projector when the imaging condition includes a condition indicating a standard lens being used for capturing the image, as in Example 1. The controller 11 designates the 360-degree virtual projector when the imaging condition includes a condition indicating a 360-degree camera (an omnidirectional camera) being used for capturing the image, as in Example 4. The controller 11 sends the settings for the designated virtual projector determined in S5 to the GPU 22 in S42 of a conversion process described later (see FIG. 5).

In S6 the controller 11 obtains model parameters including the size and shape of the corresponding concave 3D projection surface (F or K) and sets a 3D model that includes a model projection surface corresponding to the concave 3D projection surface. The controller 11 sets the 3D model U1 for Examples 1, 2, and 4, and sets the 3D model U2 for Example 3. When the controller 11 modifies the configuration of the 3D model in S23, the model parameters obtained in S6 represents the 3D model having the modified configuration.

In S7 the controller 11 obtains the position (including orientation or posture) of the designated virtual projector in the 3D model as the prescribed position. The prescribed position may be preset, specified by the user, or set through the process of S23. In the present embodiment, the prescribed position is the position such that, when the designated virtual projector is in the prescribed position, an optical axis W of the lens in the designated virtual projector is orthogonal to a first surface of the model projection surface. Specifically, the prescribed position is the position such that, when the designated virtual projector is in the prescribed position, the optical axis W of the lens passes through the center of the first surface of the model projection surface. The distance between the first surface and the designated virtual projector is set appropriately according to the shape of the 3D projection surface.

As shown in FIG. 3C, the prescribed position for Examples 1, 2, and 4 is the position such that, when a designated virtual projector PR is in the prescribed position, the optical axis W of a lens L in the designated virtual projector PR is orthogonal to the first surface UF1 of a model projection surface UF and passes through the center M of the first surface UF1. The model projection surface UF is the surface that the 3D model U1 represents, and the model projection surface UF corresponds to the 3D projection surface F. Surfaces UF1 through UF5 of the model projection surface UF correspond to the surfaces F1 through F5 of the 3D projection surface F, respectively.

As shown in FIG. 3D, the prescribed position for Example 3 is the position such that, when the designated virtual projector PR is in the prescribed position, the optical axis W of the lens L in the virtual projector PR is orthogonal to the first surface UK1 of a model projection surface UK and passes through the center M of the first surface UK1. The model projection surface UK is the surface that the 3D model U2 represents as the 3D projection surface K. Surfaces UK1 through UK5 and UC1 and UC2 of the model projection surface UK correspond to the surfaces K1 through K5 and C1 and C2 of the 3D projection surface K, respectively. Since the surface UC1 corresponds to the curved surface C1, the surface UC1 represents a curved surface. However, when the surface UC1 is represented using polygons, the surface UC1 actually represents the curved surface by connecting a plurality of planes at specific angles to one another. This holds true for the surface UC2. In the embodiment, a structure represented by a plurality of planes or polygons in this manner is referred to as a "curved surface" in the virtual space. The 3D model is not limited to a model represented polygons.

In S8 the controller 11 obtains the installation position (including orientation or posture) of the projector 3 with the fisheye lens 4 relative to the 3D projection surface. The installation position of the projector 3 relative to the 3D projection surface is obtained as three-dimensional coordinates in a world coordinate system. In S9 the controller 11 obtains characteristics of the fisheye lens 4. The lens characteristics include parameters related to focal length, lens distortion, and the optical center of the fisheye lens 4. In S11 the controller 11 executes a conversion process to convert the image data obtained in S4 into 2D image data for projection by the projector 3. In the present embodiment, the image data is video data, and the conversion process is executed for each frame in the video data.

FIG. 5 is a flowchart illustrating the conversion process. In S41 of FIG. 5, the controller 11 obtains image data for the current frame in the video data as the image data to be processed. In S42 the controller 11 transmits various parameters to the GPU 22 for obtaining, from the image data, 2D image data to be used for projection. Based on the parameters sent in S42, in S43 through S45 the controller 11 converts projection results obtained when virtually projecting an image based on image data onto a model projection surface using the designated virtual projector determined in S5 into 2D image data virtually captured when using a virtual fisheye lens while the projector is located at a virtual position corresponding to the installation position obtained in S8. Here, the captured image data may have a resolution the same as the image data of the current frame or a resolution the same as the projector 3.

Specifically, based on the installation position of the projector 3 relative to the 3D projection surface obtained in S8, in S43 the controller 11 virtually captures an image of the model projection surface using a virtual fisheye lens N disposed at a virtual installation position in the virtual space corresponding to the installation position of the projector 3 to obtain 2D coordinate data representing the model projection surface in two-dimensional coordinates (pixel coordinates). Here, the 2D dimensional coordinates specify a position of each pixel in the 2D image data and correspond to a row and a column of the 2D image data. In this case, the controller 11 identifies the two-dimensional coordinates corresponding to positions of portions (vertices) of the model projection surface. That is, each pixel associated with the identified two-dimensional coordinates represents a portion (a portion specified by a vertex) of the model projection surface. As shown in FIG. 3C, the controller 11 obtains 2D coordinate data when virtually capturing the model projection surface UF using the virtual fisheye lens N of a virtual camera CA for Examples 1, 2, and 4. The virtual fisheye lens N has the same or similar lens characteristics as the fisheye lens 4 in the projector 3. The virtual fisheye lens N is disposed at the virtual position corresponding to the installation position of the projector 3 relative to the 3D projection surface F. In other words, the position of the fisheye lens 4 relative to the 3D projection surface F is the same as the position of the virtual camera CA relative to the model projection surface UF.

Similarly, as shown in FIG. 3D, the controller 11 obtains 2D coordinate data when virtually capturing the model projection surface UK using the fisheye lens N of the virtual camera CA for Example 3. The virtual fisheye lens N has the same or similar lens characteristics as the fisheye lens 4 in the projector 3. The virtual fisheye lens N is arranged at the virtual position corresponding to the installation position of the projector 3 relative to the 3D projection surface K. In other words, the position of the projector 3 relative to the 3D projection surface K is the same as the position of the virtual camera CA relative to the model projection surface UK.

The process of S43 is achieved using vertex shaders (custom shaders) preconfigured in the GPU 22. The vertex shaders convert information on three-dimensional polygons representing the 3D model into a rectangular coordinate system. Normally, the controller 11 projects the 3D model onto a two-dimensional (2D) plane via perspective projection to generate a 2D image. The controller 11 obtains 2D coordinate data suited to the projector 3 having the fisheye lens 4 by replacing the central projection method with an equidistant projection method based on the characteristics of the fisheye lens.

In normal imaging using perspective projection, the coordinates of a 2D image are calculated by performing one matrix multiplication per vertex of the 3D model using a perspective transformation matrix. However, the coordinates of a 2D image cannot be found through simple matrix operations with vertex shaders using equidistant projection. Thus, the controller 11 in the present embodiment performs the process of S43 using shaders. The controller 11 may eliminate information waste in S43 through such processes as back-face culling, clipping, attribute evaluation, and rasterization. Through the process of S43 the controller 11 can determine the 2D coordinates of each vertex of the model projection surface based on the vertex data in the projection results of the 3D model.

In S44 the controller 11 performs a rasterization process on the vertex data processed in S43. In the rasterization process, the controller 11 combines vertex data to generate polygons representing transformed model data of the 3D model and determines the placement of pixels for drawing each polygon onto the 2D image data.

In S45 the controller 11 generates 2D image data based on the 2D coordinate data obtained in S43 and the projection results obtained when virtually projecting the image data onto the model projection surface using the designated virtual projector disposed at the prescribed position relative to the model projection surface. The 2D image data includes image signals to be outputted to the projector 3. Based on color information in the image data and correspondences between the image data and the 2D coordinate data, the controller 11 in the present embodiment generates 2D image data having color information set for the 2D coordinate data. The process of S45 may be executed using custom pixel shaders.

The controller 11 applies pixel shaders to process each pixel to which the process of S44 has been applied. The pixel shader process identifies the correspondences between the image data and the 2D coordinate data based on the designated virtual projector determined in S5. When the designated virtual projector is the standard virtual projector, the controller 11 identifies correspondences between the image data and 2D coordinate data based on the framework information for the 3D model. When the designated virtual projector is the fisheye virtual projector or the 360-degree virtual projector, the controller 11 performs calculations for mapping the image data to projected positions on the 3D model when the image data is projected radially from the virtual projector, which is arranged in a prescribed orientation at the prescribed position obtained in S7. The prescribed orientation in the present embodiment is the orientation at which the optical axis W is orthogonal to the first surface of the model projection surface. This enables the controller 11 to identify correspondence between the image data captured using the fisheye lens and the 2D coordinate data.

The method of calculating the projection range differs between the fisheye virtual projector and the 360-degree virtual projector. With the 360-degree virtual projector, the controller 11 calculates the elevation and azimuth angles for each point on the 3D model, based on the point of origin set by the prescribed position and orientation of the virtual projector. The controller 11 can find the texture coordinates of image data captured with a 360-degree camera from the elevation and azimuth angles. This enables the controller 11 to identify correspondence between the image data captured using the 360-degree camera and the 2D coordinate data.

Based on the color information, the image data, and the correspondences between the image data and the 2D coordinate data, the controller 11 generates 2D image data by assigning the color and transparency in the 2D coordinate data to each pixel. That is, the controller 11 assigns the color and transparency at the positions of texture coordinates contained in the vertex data for the vertices in the texture image as the color and transparency for the pixels corresponding to the polygon vertices. The color and transparency of pixels that do not correspond to polygon vertices are determined by interpolating the colors and transparencies assigned to the polygon vertices. In addition to determining the color and transparency of pixels using the pixel shaders, the controller 11 may apply processes such as alpha testing, depth testing, stencil testing, and blending.

In S12 (FIG. 2) the controller 11 outputs image signals for the 2D image data to the projector 3 and uses the projector 3 to project an image onto the 3D projection surface based on the 2D image data. The projector 3 projects the image based on the image data onto the 3D projection surface in accordance with the image signals received from the projector 3.

In Example 1, the projector 3 projects an image based on 2D image data constituting the image data G1 shown in FIG. 6A onto the 3D projection surface F and obtains projection results that reproduce projection results P1 shown in FIG. 6B. In the projection results P1, the image data G1 is projected onto the 3D projection surface F. The image projected onto the fourth surface F4 and fifth surface F5 produce U-shaped projection results such that the opening of the “U” faces in the direction opposite the direction from the projector 3 toward the first surface F1. The center of the projected image coincides with the center of the first surface F1.

FIG. 6C shows projection results P2 in the comparative example. The projection results P2 contain distortion from the virtual fisheye lens in the designated virtual projector, resulting in curved contours in the projection results P2. In contrast, the projection results P1 in Example 1 contain no fisheye lens distortion. Thus, the contours of the projection results P1 are straight, producing projection results with less distortion that cause less discomfort to the viewer than the projection results P2.

In Example 2, the projector 3 projects an image based on 2D image data constituting the image data G2 shown in FIG. 7A onto the 3D projection surface F, obtaining projection results that reproduce projection results P3 shown in FIG. 7B. In Example 3, the projector 3 projects an image based on 2D image data constituting image data G2 onto the 3D projection surface K, obtaining projection results that reproduce projection results P4 shown in FIG. 7C. Since the connecting parts between the horizontally adjacent first surface K1 and second surface K2 and the horizontally adjacent first surface K1 and third surface K3 are curved surfaces, the 3D projection surface K in the projection results P4 contains no edges extending in the vertical direction. However, both projection results P3 and P4 have little distortion and cause little discomfort, regardless the shape of the 3D projection surface. In Example 4, the projector 3 projects 2D an image based on image data constituting the image data G3 shown in FIG. 8A onto the 3D projection surface F, obtaining projection results that reproduce projection results P5 shown in FIG. 8B.

As demonstrated by Examples 1 through 4, the projection system 1 obtains projection results that cause less discomfort than the known technology for each of the plurality of types of image data having different imaging conditions.

In S31 the controller 11 determines whether to end the projection control process. The controller 11 determines to end the projection control process when the last frame is projected or when detecting that an instruction to quit the projection control process is inputted by the user via the input interface 14.

When an instruction to quit the projection control process is not detected (S31: NO), in S32 the controller 11 determines whether a position modification instruction to change the projection position is detected. When the projection position is modified, the correspondence changes between a representative point on the model projection surface and a representative point in the image data. The representative points may be the center points, for example. When the user wishes to change the projection position, the user operates the joystick on the input interface 14 to specify an intended projection position. For example, when the user wishes to shift the projection results rightward from the current position, the user tilts the joystick to the right.

When a position modification instruction is detected (S32: YES), in S33 the controller 11 changes the setting for the position of the image data relative to the model projection surface in accordance with the position modification instruction detected in S32. When the controller 11 subsequently repeats the conversion process of S11, in S45 of this process the controller 11 uses the designated virtual projector located at the prescribed position to generate 2D image data by virtually projecting an image based on the image data at the projection position on the model projection surface specified by the position modification instruction.

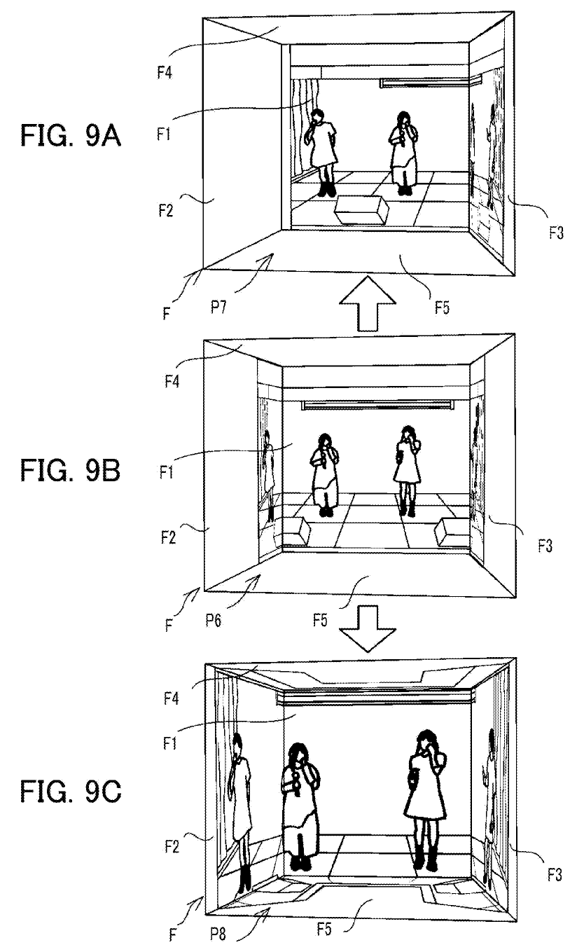

When the designated virtual projector is the standard virtual projector, the controller 11 changes the applied positions of textures in the image data obtained in S41 upward, downward, leftward, or rightward in accordance with the position modification instruction. When the designated virtual projector is the fisheye virtual projector or the 360-degree virtual projector, the controller 11 changes the orientation (angle) of the virtual projector in accordance with the position modification instruction. When the projection system 1 yields projection results P6 in Example 1, as illustrated in FIG. 9B, and the controller 11 detects an instruction in S32 to move the projection results rightward (S32: YES), in S12 the controller 11 will produce projection results P7 shown in FIG. 9A.

After modifying the setting in S33 or when a position modification instruction is not detected (S32: NO), in S34 the controller 11 determines whether a magnification modification instruction to modify the projection magnification is detected. When the user wishes to change the projection magnification, the user operates the directional pad on the input interface 14 to specify an intended projection magnification. For example, when the user wishes to increase the projection magnification, the user presses the top side of the directional pad.

When the controller 11 detects a magnification modification instruction (S34: YES), in S35 the controller 11 changes the setting for projection magnification of the image data in accordance with the instruction. When the controller 11 subsequently repeats the conversion process of S11, in S41 of the conversion process the controller 11 uses the designated virtual projector disposed in the prescribed position (or position and orientation changed in S33 when S33 is executed) to obtain projection results by virtually projecting an image based on image data onto the model projection surface at the projection magnification specified by the magnification modification instruction when S35 is executed. Here, the process of S41 executed after the NO determination made in S31, the controller may obtain image data for a next frame. In the example in FIG. 9, when the controller 11 detects an instruction in S34 to increase the projection magnification for the projection results P6 of Example 1 (S32: YES), the controller 11 produces projection results P8 shown in FIG. 9C in S12.

Following the modification in S35 or when the controller 11 determines that an instruction to modify the projection magnification is not detected (S34: NO), the controller 11 returns to S11. When the controller 11 detects an instruction to quit the projection control process (S31: YES), the controller 11 stores the current settings in the storage 15 and ends the process described above.

The projection system 1, the projection control device 2, and the fisheye lens 4 are respectively examples of the projection system, the projection control device, and the fisheye lens. The process of S6 is an example of the model setting process. The process of S4 is an example of the image obtaining process. The process of S5 is an example of the virtual projector setting process. The process of S43 is an example of the pixel-position identifying process. The process of S45 is an example of the generating process. The process of S21 is an example of the reference projecting process. The process of S22 is an example of the receiving process. The process of S23 is an example of the modification process. The process of S32 is an example of the position modification process. The process of S34 is an example of the magnification modification process.

The projection system 1 of the present embodiment includes the projector 3 with the fisheye lens 4, and the projection control device 2 that controls image projection by the projector 3. In S4 of FIG. 2, the projection control device 2 executes an image obtaining process to obtain image data to be processed. In S6 the projection control device 2 executes a model setting process to obtain model parameters containing the size and shape of the concave 3D projection surface in order to set a 3D model. In S5 the projection control device 2 executes a virtual projector determining process to designate one of a plurality of virtual projectors as the designated virtual projector based on the imaging condition of the image data. In S43 of FIG. 5 the projection control device 2 executes a 2D coordinate data conversion process to virtually capture the model projection surface that represents a 3D projection surface with a 3D model using a virtual fisheye lens disposed at the virtual installation position corresponding to the installation position of the projector 3 and obtains 2D coordinate data of the model projection surface. In S45 the projection control device 2 executes a 2D image data generation process to generate 2D image data based on projection results and 2D coordinate data when the image data is virtually projected onto the model projection surface using the designated virtual projector disposed at the prescribed position relative to the model projection surface. In S12 the projection control device 2 executes an image projecting process to project the image based on the 2D image data onto the 3D projection surface using the projector 3.

Normally, when an image is projected by a projector with a fisheye lens, distortion specific to that fisheye lens is produced in the projected image. Similarly, when an image is captured by a camera with a fisheye lens, distortion specific to that fisheye lens is produced in the captured image. Since image capture and image projection are inverse conversions, distortion produced during image capture is offset by image projection when the image data captured with a fisheye lens is projected with a fisheye lens having the same characteristics as the fisheye lens used for image capture. As a result, a projected image with reduced distortion can be obtained without performing any correction specific to the fisheye lens.

The projection control device 2 of the projection system 1 simulates an ideal projection environment for the imaging condition by obtaining projection results using the virtual projector appropriate for each of a plurality of imaging conditions corresponding to the image data. The projection control device 2 of the projection system 1 converts the projection results in the ideal projection environment into 2D image data when the image is captured by the virtual fisheye lens N at the virtual installation position corresponding to the installation position of the projector 3. This enables the projection control device 2 of the projection system 1 to generate 2D image data capable of reproducing projection results in the ideal projection environment through projection from a realistic projection environment based on 2D image data corresponding to the imaging condition through a relatively simple process. In other words, the projection control device 2 can perform both planar projection (projection onto a flat surface) and three-dimensional projection (projection onto has a curved surface) corresponding to imaging conditions in the same device. Therefore, based on image data under multiple imaging conditions, the projection system 1 can produce projected images with less distortion than the known technology, causing less discomfort to the viewer. This holds true regardless of the installation position of the projector 3 and even when the projected surface has any three-dimensional shape, all while using simpler processes than the known methods.

In the virtual projector determining process of S5, a fisheye virtual projector that virtually projects an image based on image data so as to be conform to the model projection surface using a virtual fisheye lens is set as the designated virtual projector when the imaging condition includes the condition that a fisheye lens is used for capturing images. In the virtual projector determining process, a standard virtual projector that virtually projects image data so as to be conform to the model projection surface is set as the designated virtual projector when the imaging condition includes the condition that a standard lens is used for capturing images. The projection system 1 can control the projector 3 to project each of image data captured using a fisheye lens and image data captured using a standard lens onto a concave 3D projection surface with less distortion than the known method.

In the model setting process of S6, a 3D model is set by obtaining model parameters that define a model projection surface corresponding to a 3D projection surface that has five surfaces including a first surface, and four surfaces continuous with the first surface. Through a process that is simpler than the known technology, the projection system 1 can set a 3D model with relatively simple settings and obtain projected images that cause less discomfort to the viewer, regardless of the imaging conditions of the image data and the installation position of the projector 3.

In the model setting process of S6, a 3D model is set by obtaining model parameters that define a model projection surface having virtual five surfaces including a first surface facing the virtual fisheye lens, and four surfaces continuous with the first surface. The prescribed position is the position of the designated virtual projector at which the optical axis W of the lens is orthogonal to the first surface. Since the projection system 1 sets the prescribed position so that the virtual projector faces a virtual surface corresponding to the first surface of the 3D projection surface, the projection system 1 can more easily simulate an ideal projection environment than under a condition in which the projector at the prescribed position does not face the first surface, thereby facilitating the process of obtaining projection results.

In the model setting process of S6, a 3D model is set by obtaining model parameters that define a model projection surface corresponding to a 3D projection surface with a first surface facing the fisheye lens 4 of the projector 3. The projection position of the virtual projector PR is set so that the optical axis W of the lens L passes through the center M of the virtual first surface of the model projection surface. The projection system 1 sets the prescribed position on a virtual line extending from the center of the virtual first surface of the model projection surface in a direction orthogonal to the virtual first surface. Thus, the projection system 1 can more easily simulate an ideal projection environment than under other conditions, thereby facilitating the process of virtually projecting image data onto the model projection surface.

The model setting process of S6 sets a 3D model by obtaining model parameters that defines a model projection surface corresponding to a 3D projection surface having a first surface that faces the fisheye lens 4 of the projector 3 and extends in the vertical direction; second and third surfaces that intersect the first surface and extend in the vertical direction; and fourth and fifth surfaces that intersect the first surface and extend in the horizontal direction. The first and second surfaces may be connected by a first curved surface, and the first and third surfaces may be connected by a second curved surface. In a 3D projection surface, generally the connecting parts that form an edge between the first surface and second surface and an edge between the first surface and third surface are more prone to image distortion than the flat surfaces. However, the projection system 1 is less likely to produce distortion in the connecting part between the first and second surfaces and the connecting part between the first and third surfaces when projecting an image onto the 3D projection surface including the first and second curved surfaces than when the 3D projection surface does not include the first and second curved surfaces.

The image data includes the imaging condition. In the virtual projector determining process, a designated virtual projector is determined from among a plurality of virtual projectors based on the imaging condition associated with the image data. Enabling the projection system 1 to determine a designated virtual projector based on the imaging condition associated with the image data saves the user of the projection system 1 the trouble of inputting the imaging condition.

In the process of S45 for generating 2D image data, 2D image data with color information set in 2D coordinate data is generated based on color information in the image data and correspondences between the image data and the 2D coordinate data. The projection system 1 can generate 2D image data with color information set in the 2D coordinate data using a relatively simple process based on the color information in the image data and the correspondences between the image data and the 2D coordinate data.

In S21 of FIG. 2 the projection control device 2 executes a reference projection process in which a reference image showing the configuration status of the 3D model is projected onto the 3D projection surface via the fisheye lens 4. After initially projecting the reference image, in S22 the projection control device 2 executes a reception process to accept a setting modification instruction for modifying the configuration of the 3D model. In response to the setting modification instruction, in S23 the projection control device 2 executes a correction process to correct the reference image projected onto the 3D projection surface by changing the settings for the 3D model. The projection system 1 can change settings for the 3D model through a relatively simple process while projecting the reference image onto the actual 3D projection surface. In this way, the user of the projection system 1 can verify the configuration status of the 3D model based on the reference image projected onto the 3D projection surface.

In S32 the projection control device 2 executes a position modification instruction obtaining process to obtain a position modification instruction for modifying the projection position of the image based on the image data relative to the model projection surface. In a 2D image data generation process performed when a position modification instruction is obtained, the projection control device 2 generates 2D image data by virtually projecting an image based on image data at the projection position on the model projection surface specified by the position modification instruction. Thus, the projection system 1 can project image data onto the 3D projection surface at the modified projection position through a relatively simple process.

In S35 the projection control device 2 executes a magnification modification instruction obtaining process for obtaining a magnification modification instruction to change the projection magnification of the image data. In a 2D image data generation process performed when a magnification modification instruction is obtained, the projection control device 2 generates 2D image data by virtually projecting an image based on image data onto the model projection surface at the projection magnification specified in the magnification modification instruction. Thus, the projection system 1 can project image data onto the 3D projection surface at the modified projection magnification through a relatively simple process.

While a projection system, projection control device, and projection control program of the invention have been described in detail with reference to a specific embodiment thereof, it would be apparent to those skilled in the art that many modifications and variations may be made therein without departing from the scope of the disclosure, which is defined by the attached claims. For example, the following modifications may be incorporated as appropriate.

The configurations of the projection system, the projection control device, and the projection control program may be modified as appropriate. The projector 3 and the projection control device 2 may be configured as an integrated device. The projection control device may be a special-purpose device, a general-purpose device such as a PC.

The projection control program, which contains instructions for executing the projection control process, may be stored in the storage 15 or the memory 23 until the controller 11 of the projection control device 2 executes the projection control program. Therefore, the method of obtaining the projection control program, the obtaining path, and the device storing the program may each be modified as appropriate. The projection control program may be received from another device through a cable or wireless communication connection and stored in the storage 15 or memory 23. Examples of other devices include PCs, and servers connected via a network.

While the controller 11 executes each step of the projection control process in the above example, all or some steps may be executed by another electronic device (e.g., an ASIC). An ASIC is just one example of another electronic device. For example, the steps of the projection control process may be executed through distributed processing performed by a plurality of CPUs. Steps may also be added to or omitted from the projection control process, and the order of the steps may be modified as appropriate. The following modifications may be incorporated in processes executed on the projection system 1, including the projection control process.

As long as the 3D projection surface is concave, the shape of the surface may be hemispherical or otherwise modified as appropriate. The process for changing the 3D model may also be modified as appropriate. When the projection control device 2 includes a sensor for measuring the distance to and the shape of the 3D projection surface, the projection control device 2 may automatically set the 3D model based on the detection results of the sensor. The pattern of the reference image may be modified as appropriate, such as a pattern that represents the shape of the first surface but does not include the shapes of other surfaces. The projection control device 2 may not be capable of performing a process to change the 3D model based on a reference image. The configurable settings for the 3D model may be modified as appropriate. For example, the projection control device 2 may not possess a function for correcting a trapezoidal surface or may not possess a function for correcting connecting parts between two adjacent surfaces among the surfaces configuring the model projection surface to curved surfaces. Among the plurality of surfaces constituting the 3D projection surface, connecting parts between two surfaces adjacent in the vertical direction may also be curved. When the size and shape of the 3D projection surface is known, as with the screen E, the 3D model may be set based on model parameters including the size and shape of the 3D projection surface, which are inputted by the user.

The plurality of types of preset virtual projectors may be modified as appropriate. For example, the plurality of types of virtual projectors may be set to any two of the standard virtual projector, fisheye virtual projector, and 360-degree virtual projector in the above embodiment. The plurality of types of virtual projectors may also include projectors other than the standard virtual projector, fisheye virtual projector, and 360-degree virtual projector. The image data may not include imaging conditions, and the controller 11 may set the designated virtual projector to a virtual projector selected by the user. The controller 11 may also determine the designated virtual projector based on the aspect ratio of the image. The prescribed position of the designated virtual projector may not be the position at which the optical axis of the lens in the designated virtual projector is orthogonal to the first surface of the model projection surface or a position at which the optical axis of the lens in the designated virtual projector passes through the center of the first surface configuring the model projection surface. The process from S32 to S35 may be omitted as appropriate. In the 2D image data generation process of S45, the method of generating the 2D image data may be modified as appropriate, provided that the 2D image data is generated based on projection results and the 2D coordinate data obtained in S43.

In this disclosure, the term “magnification” is not limited to enlargement but may also include reduction, such as when the value is less than one. Therefore, “magnification” is used as a concept encompassing scaling and resizing.

Note that the present disclosure includes the phrases “at least one of A and B”, “at least one of A, B and C”, and the like as alternative expressions that mean one or more of A and B, one or more of A, B and C, and the like, respectively. More specifically, the phrase “at least one of A and B” means (A), (B) or (A and B), and the phrase “at least one of A, B and C” means (A), (B), (C), (A and B), (A and C), (B and C) or (A, B and C).

The term “processor” encompasses both a single processor or a group of multiple processors located either locally or remotely working together or in a distributed fashion to collectively perform the tasks attributed to the “processor” described herein. One or more processors may be referred to as a controller.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

What is claimed is:

1. A projection system comprising:
a projector including a fisheye lens; and
a projection control device configured to perform:
an image obtaining process including:
obtaining first image data captured under an imaging condition;
a model setting process including:
obtaining model parameters defining a three-dimensional model represented in a virtual space, the three-dimensional model including a model projection surface, the model projection surface corresponding to a projection surface in a physical space;
a virtual projector setting process including:
selecting a target virtual projector from a plurality of virtual projectors based on the imaging condition;
a pixel-position identifying process including:
virtually capturing, in the virtual space, second image data representing the model projection surface using a virtual fisheye lens at a virtual lens position, a positional relationship between the virtual lens position and the model projection surface corresponding to a positional relationship between an installation position and the projection surface in the physical space; and
identifying one or more sets of two-dimensional pixel coordinates in the second image data, each of the one or more sets of two-dimensional pixel coordinates corresponding to a portion of the model projection surface;
a generating process including:
virtually projecting, in the virtual space, an image based on the first image data onto the model projection surface using the target virtual projector located at a prescribed position; and
generating third image data based on the one or more sets of two-dimensional pixel coordinates and the virtually projected image; and
a projecting process including:
projecting an image based on the third image data onto the projection surface using the projector in a state where the projector is placed at the installation position.

2. The projection system according to claim 1,
wherein when the imaging condition indicates that the first image data is captured using a fisheye lens, the selecting selects, as the target virtual projector, a virtual projector having a virtual fisheye lens from the plurality of virtual projectors,
wherein when the imaging condition indicates that the first image data is captured using a non-fisheye lens, the selecting selects, as the target virtual projector, a virtual projector having a virtual non-fisheye lens from the plurality of virtual projectors.

3. The projection system according to claim 1,
wherein the model projection surface includes a main surface and four surrounding surfaces that surround the main surface and are continuous with the main surface.

4. The projection system according to claim 3,
wherein an optical axis of a virtual lens of the target virtual projector located at the prescribed position is orthogonal to the main surface.

5. The projection system according to claim 3,
wherein an optical axis of a virtual lens of the target virtual projector located at the prescribed position passes through a center of the main surface.

6. The projection system according to claim 1,
wherein the model projection surface represents the projection surface that includes:
a first flat surface extending vertically;
a second flat surface extending vertically and nonparallel to the first flat surface;
a third flat surface extending vertically and nonparallel to the first flat surface;
a fourth flat surface extending horizontally and connected to the first flat surface;
a fifth flat surface extending horizontally and connected to the first flat surface;
a first curved surface connecting the first flat surface to the second flat surface; and
a second curved surface connecting the first flat surface to the third flat surface.

7. The projection system according to claim 1,
wherein the first image data includes information on the imaging condition.

8. The projection system according to claim 1,
wherein the third image data includes color information for each of pixels in the third image data.

9. The projection system according to claim 1,
wherein the projection control device is configured to further perform:
a reference projecting process including:
projecting a reference image onto the projection surface using the projector in a state where the projector is placed at the installation position, the reference image representing a configuration of the three-dimensional model;
a receiving process including:
receiving an instruction to modify the configuration of the three-dimensional model during the reference projecting process; and
a modification process including:
modifying the three-dimensional model according to the instruction; and
projecting a modified reference image onto the projection surface, the modified reference image representing the modified configuration of the three-dimensional model,
wherein when the modification process is performed, the pixel-position identifying process and the generating process are performed using the three-dimensional model modified according to the instruction.

10. The projection system according to claim 1,
wherein the projection control device is configured to further perform:
a receiving process including:
receiving an instruction to modify a position of the virtually projected image on the model projection surface,
wherein the generating process further includes:
projecting, onto the model projection surface in the virtual space, a modified image in a position modified based on the instruction using the target virtual projector; and
generating fourth image data based on the one or more sets of two-dimensional pixel coordinates and the modified image.

11. The projection system according to claim 1,
wherein the projection control device is configured to perform:
a receiving process including:
receiving an instruction to scale the virtually projected image on the model projection surface,
wherein the generating process further includes:
projecting, onto the model projection surface in the virtual space, an image scaled based on the instruction using the target virtual projector; and
generating fourth image data based on the one or more sets of two-dimensional pixel coordinates and the scaled image.

12. The projection system according to claim 1,
wherein the model projection surface includes a concave surface.

13. A projection control device comprising:
a controller including one or more processors, the controller being configured to perform:
an image obtaining process including:
obtaining first image data captured under an imaging condition;
a model setting process including:
obtaining model parameters defining a three-dimensional model represented in a virtual space, the three-dimensional model including a model projection surface, the model projection surface corresponding to a projection surface in a physical space;
a virtual projector setting process including:
selecting a target virtual projector from a plurality of virtual projectors based on the imaging condition;
a pixel-position identifying process including:
virtually capturing, in the virtual space, second image data representing the model projection surface using a virtual fisheye lens at a virtual lens position, a positional relationship between the virtual lens position and the model projection surface corresponding to a positional relationship between an installation position and the projection surface in the physical space; and
identifying one or more sets of two-dimensional pixel coordinates in the second image data, each of the one or more sets of two-dimensional pixel coordinates corresponding to a portion of the model projection surface;
a generating process including:
virtually projecting, in the virtual space, an image based on the first image data onto the model projection surface using the target virtual projector located at a prescribed position; and
generating third image data based on the one or more sets of two-dimensional pixel coordinates and the virtually projected image; and
a projecting process including:
projecting an image based on the third image data onto the projection surface using a projector including a fisheye lens in a state where the projector is placed at the installation position.

14. A non-transitory computer readable storage medium having instructions stored thereon that, when executed, cause a controller, which includes one or more processors, to perform:
an image obtaining process including:
obtaining first image data captured under an imaging condition;
a model setting process including:
obtaining model parameters defining a three-dimensional model represented in a virtual space, the three-dimensional model including a model projection surface, the model projection surface corresponding to a projection surface in a physical space;
a virtual projector setting process including:
selecting a target virtual projector from a plurality of virtual projectors based on the imaging condition;
a pixel-position identifying process including:
virtually capturing, in the virtual space, second image data representing the model projection surface using a virtual fisheye lens at a virtual lens position, a positional relationship between the virtual lens position and the model projection surface corresponding to a positional relationship between an installation position and the projection surface in the physical space; and
identifying one or more sets of two-dimensional pixel coordinates in the second image data, each of the one or more sets of two-dimensional pixel coordinates corresponding to a portion of the model projection surface;
a generating process including:
virtually projecting, in the virtual space, an image based on the first image data onto the model projection surface using the target virtual projector located at a prescribed position; and
generating third image data based on the one or more sets of two-dimensional pixel coordinates and the virtually projected image; and
a projecting process including:
projecting an image based on the third image data onto the projection surface using a projector including a fisheye lens in a state where the projector is placed at the installation position.
